(19) United States
(12) Patent Application Publication
(10) Pub. No.: US 2004/0073802 A1
(43) Pub. Date: Apr. 15, 2004

(54) User identification with an improved password input method

(76) Inventor: Dong-Seok Seol, Seoul (KR)

Correspondence Address: GREENBLUM & BERNSTEIN, P.L.C., 1950 ROLAND CLARKE PLACE, RESTON, VA, 20191, US

(21) Appl. No.: 10/468,160

(22) PCT Filed: Feb. 28, 2002
(86) PCT No.: PCT/KR02/00336

(30) Foreign Application Priority Data
Mar. 2, 2001 (KR) 2001/10863

(51) Int. Cl. H04L 9/00

(52) U.S. Cl. 713/183

(57) ABSTRACT

The present invention relates to a user identification method that uses an indirect password. This method allows a password control system to identify a user with a received value, which is calculated by a predetermined function known to both the user and the password control system, and a value of a variable. The variable being provided from the password control system. According to the present invention, the password is less likely to be misappropriated in the input stage and interception on the transmission line by hacking would be futile.

### FIELD OF THE INVENTION

The present invention relates to a method for identification of a user by an indirect password which allows a password control system to identify a user by the input of a value, which is calculated by a predetermined function formulated in advance between a user and a password control system, and variables which are provided from the password control system, and more particularly to a method to identify a user by a password control system whereby a password cannot be embezzled even if an embezzler looks at the user's operation of inputting a password.

### BACKGROUND OF THE INVENTION

When a user tries to run a kind of application programs or to connect to a particular site on the Internet, it is mostly required to input user ID and password. On the condition that inputted ID and password coincides with registered ID and password respectively, an authority to run program or to profit various contents of the site is to be endowed.

However there are many problems in such a conventional technique. For example, in spite of turn-limitation to password input error by bank, card company, etc, which manage a lot of identifiers, may take, a relationship between user identifier and password is so constant that the identifier corresponding to the password can be found; rules to input password are so well-known that others can find out the password corresponding to the identifier to embezzle an authority of the legitimate user by the various means of looking at user inputting password beside him or with secret camera, checking a program which saves inputted contents, intercepting on the communication line, wire tapping and steeling saved password, etc.

On the other hand, if the identifier and the password are revealed at least once or steeled through said ways, after then, the embezzler could use them without any difficulty and even it can be tried that the embezzler uses all the collected passwords of the identifier at a time.

That is to say, in such a conventional technique, if it is seen to input password and identifier or registered password and identifier are disclosed, any body can use them directly because the password which user made, is consisted of a constant length of string, number or composition which is composed of character, numeral and ideogram.

The present invention is designed to solve the above problems. The objective of the present invention is to provide a method for identification a user by a indirect password, which utilizes a password control system. The invention allows a user to design a method to input password corresponding to authorities as much as he wants, to express authorities to the identifier from the beginning so that the password cannot be recognized even though it is looked to input password, and to input a result generated by a registered calculation method when user inputs password, where the user is identified by an indirect method which does not receive a calculation and function directly but receive a result generated by a calculation and function so as to check whether who inputs password knows a calculation and function composed of user-defined variables, so that others cannot use the password.

To achieve the above object, the present invention is characterized in that only a resulted value generated by a input method, which user himself knows, is inputted; a channel umber, which classifies a method to use authorities, is included into the inputted content; and it should be inputted within a predetermined range of response time.

### BRIEF DESCRIPTION OF THE DRAWINGS

The above objects and advantages of the present invention will become more apparent by describing in detail-preferred embodiments thereof with reference to the attached drawings in which;

FIG. 1 is a block diagram showing the structure of a password control system according to an embodiment of the present invention;

FIG. 2 is a flowchart illustrating a method for identification of a user by a password according to the present invention.

* description of reference numbers for important parts in the drawings*

| | |
|---|---|
| 1: password memory | 2: password input methods memory |
| 3: reference variable memory | |
| 4: reference signal management | |
| device | |
| 5: output device | 6: channel memory |
| 7: input device | 8: response time memory |
| 9: central processing unit | 10: temporary memory |
| 11: external interface unit | 12: communication line |

### DESCRIPTION OF THE PREFERRED EMBODIMENTS

Definitions of important terminologies for a description of the present invention are as follows.

* identifier: It denotes a thing, which has a capacity to differentiate itself from others. For example, it is digitalized one of things as like resident card. Usual card, a bankbook, USER ID, identification card, automobile, digital stamp, document, voice, iris, fingerprint; etc so that it differentiate itself from others. In the case of card, it is a card number, and in the case of fingerprint, it is a fingerprint data generated by fingerprint recognizer or fingerprint management number.

* user: It denotes who has a legitimate authority about the identifier.

* channel: It denotes one of a plurality of levels to which the user classified authority conducting methods of the identifier.

* reference signal: It denotes a variable, which is assigned and sent to the user by a password control system.

* reference variable: It denotes a variable defined by the user, which can be shared by both pass control system and the user as a data such as year, month, day, hour, minute etc.

* password input method; It denotes a method to input (or express) password with reference to calculation method, which is composed of password, reference signal, reference variable, channel etc., analysis method and order when the user inputs password.

* response time: It denotes a time used to input a result according to input method.

* indirect password input method; It denotes a method not to input password as same as registered content but to input a processed result according to a predetermined method. For example, supposing that a calculation equation is registered, not the calculation equation but calculated result is inputted. On the other hand, supposing that the specific one should be pressed at the specific time, the password would be inputted by pressing the specific one at the specific time.

According to the present invention, in a password control system so as to identify user, what he knew is checked not directly but indirectly with a method that only a result processed by known method is inputted.

To explain the present invention more easily, for example supposing that what both the user and the password control system knew is an equation, the equation is not inputted directly but a calculated result with a numeral, which is provided by the password control system, substituted for the equation is inputted.

Also, in a conventional way, all the authorities are belonged to single password without classification, but the present invention allows a user to classify authorities over the same identifier.

Those figures are extremely useful when various identifiers is unified into several identifiers as like number of resident card; risk that all the authorities are endowed by an acceptation of password can be reduced; it is difficult for an embezzler to know whether all the authorities of the user is achieved or not; because an embezzler should check all the known channels, although the user employees several channels, those figures are to be an effective means in order to prevent random access.

Because there could be various channels according to the object of usage, for example a channel to identify and report a location of user, a channel to express a content of authority fictitiously and a channel to stop the password control system accessed, etc., although user informs an embezzler a content of channel, there is no means to check whether it is true or not. Thus password can be protected from embezzlement

According to another aspect of the present invention, it is checked whether a response time is fulfilled, which a user defined, when someone tries to find password for an identifier by an computer or automated robot randomly, when someone adjusts a processing time for the purpose of extending random search time or when processing is lasted endlessly for the lack of identification.

In the present invention, password must be inputted within assigned time, which is provided by a timer of the password control system or by an individual method, but an embezzler could not calculate the time range to use so that he must take many trials and errors by a burden to comply with observed time.

Also, user can be identified more exactly by statistical way using collected data of used response time. That is, even though response time specified by the user is long, the password control system can restrict usage of important authorities of the user, by an assumption that the user is under emergency state, on the condition that a difference between response time and usual response time is large. So it can be used as a means for an emergency.

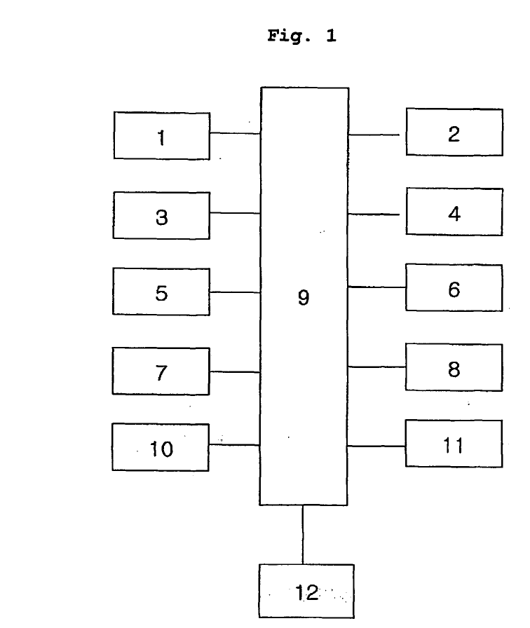

FIG. 1 shows an embodiment of the password control system adapting an idea of the present invention. The password control system according to the present invention comprises a password memory (1) for storing a password for an identifier; a password input method memory (2) for storing an equation or function having a basic variable of a password for the same identifier; a reference variable memory (3) for storing variables, which are referred to when the user inputs, and a reference signal management device (4) for managing reference signals; an output device (5); a channel memory (6) for specifying a kind of exercise of authorities for the identifier; an input device (7) to which the user inputs a result; a response time memory (8) for storing a time for responding to the input; a central processing unit (9) for comparing/analyzing the inputted response time and the result, identifying whether the registered password and equation are known, and conducting/managing a process of the channel required by the user; a temporary memory (10) necessary in processing an output port (11) communicated with the outside; and

a communication line (12) for transmitting/receiving signals among the above elements.

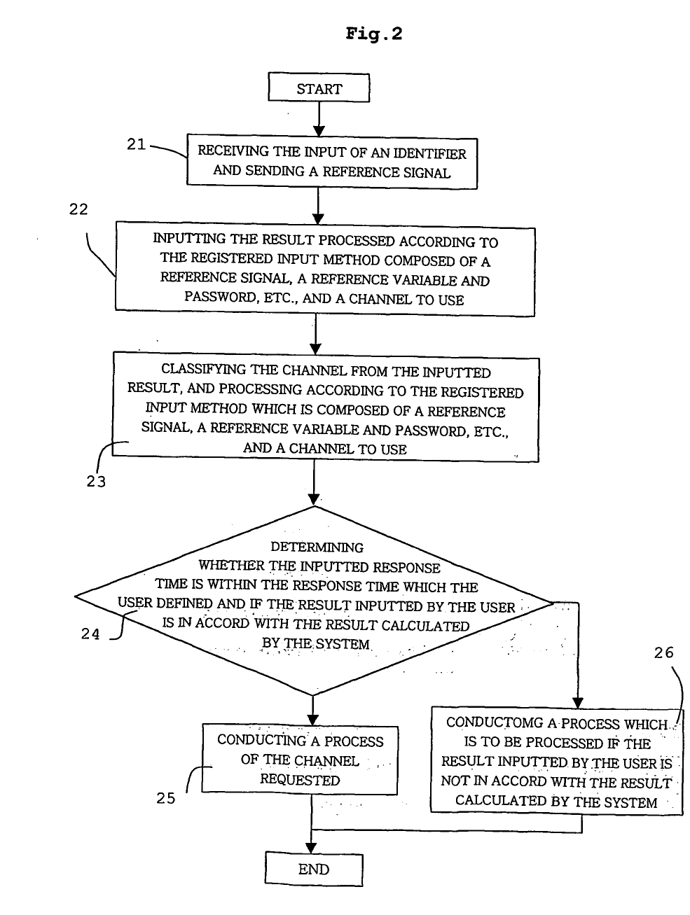

A method for identification of a user by a password control system according to the present invention, as shown by a flowchart in FIG. 2, comprises the steps of inputting an identifier which the user wishes to use (21); inputting an indirect password by the user which is processed by the pre-registered password input method and reference signals, reference variables, constants and channel provided by the password control system (22); classifying the result input by the user into an effective one and channel, and recalculating a response time according to a predetermined calculation method (23); determining whether the inputted response time is within the response time which the user defined and comparing/analyzing the inputted response time with the result calculated by the password control system (24); if the results are in accord with each other, assuming that the user is the right person for the identifier, conducting a process corresponding to the required channel. (25); and if the result input by the user is not in accord with the result calculated by the system, conducting a process for an unauthorized user (26).

A method for identification of a user by indirect password control system can be applicable to various fields of industry generally using the method that identifies what user knows for the purpose of identification and certification.

As a case in which the method of the present invention is adapted to, phone banking will be described in detail.

It can be understood that phone banking system is a password control system as shown in FIG. 1 to which an auto response system is added. Thus, the operation of the phone banking system will be described with reference to FIG. 1. Here detailed description and notation will be omitted because auto response system (ARS) is a interface device to interface with user by voice in output device (5) and input device (7) of password control system and it can be varied in accordance with the kind of terminal which is connected to the password control system.

Who wants to profit a phone banking service inputs account number to use after connection to ARS (Auto Response System) on the telephone line. (step 21 in FIG. 2)

Reference signal management device (4) of password control system selects a reference signal composed of arbitrary number and send one or more numerals to ARS, temporary memory (10) stores the content of reference signal and time to send it temporarily, and ARS sends reference signal in the form of voice. (step 22 in FIG. 2)

Meanwhile, assuming that registered password is “1234” and registered password inputting method is “password+300−reference number×10+channel number” and dealings wanted, that is, dealings less than 100,000 won is assigned to channel 3, the calculated result “15293” would be input (step 23 in FIG. 2).

Password control system checks the part which channel is inputted in the secret number input method memory (2), saves channel number which is inputted at last into the temporary memory (10), calculates the content to be inputted corresponding to the identifier in the password input method memory (2) with secret number in the password memory (1) and reference signal sent to user and channel number in the temporary memory (0) substituted, and then compares it with the content which user inputted. (step 24 in FIG. 2)

If the value which user inputted and the calculated value by password control system are coinciding each other, password control system calculates a response time until password is inputted after receipt of reference signal. If response time fulfills specified response time by user, calculated response time is stored into response time memory (8), and then specified process of the channel is conducted to use authorities within the authorities of the required channel. (step 25 in FIG. 2)

The function of channel is one of many processes, which the password control system provides, and one of processes, which defined by the password control system and user in preparation. For example the above process required user wins the service of channel 3, which should be stopped if user requires a dealings equal or more than 100,000 won.

If inputted value and calculated value are different, a process for disagreement (for example returning to the initial state etc) is conducted.

Hereinafter the more detailed description about un-described or unsatisfied part in the above description will be showed.

At first, to set password inputting method will be described.

Assuming that registered password is composed of N digits of decimal numbers,

password P can be expressed by the equation as follows,

P=P₀10⁰+P₁×10¹+. . . +P_{N-1}×10^{N-1}+P_{N}×10^{N}

and channel number Ch can be expressed by the equation as follows,

Ch=(Ch₁, Ch₂ . . . Ch_{N})

Assuming that reference signal composed of N digits of decimal numbers,

reference signal S can be expressed by the equation as follows.

S=S₀×10⁰+S₁×10¹+S_{N-1}×10^{N-1}+S_{N}×10^{N}

In the case that reference variable is defined with day and hour,

reference variable be expressed by the equation as follows.

V=(D₁, D₂ . . . D₃₀, D₃₁)

Password inputting method I can be expressed by the equation as follows.

I=f (P₀, P₁ . . . P_{N-1}, P_{N}, Ch₁, Ch₂ . . . Ch_{N}, S₀, S₁ . . . S_{N-1}, S_{N}, D₁ . . . D₃₁, H₁ . . . H₂₄, 1, 2 . . . 9, 0)

Password-inputting method and for example I can be set as follows.

I=P₀×S₁Mod10, P₁×S₁Mod10, Ch_{N}, (P₂+P₁)Mod10, P_{N-1}, Pₙ×S₁Mod100

Result Sol composed of several numerals can be expressed as follows.

Sol=(10^{N+Ch+1})

If registered password composed of 4 digits, result Sol would compose of 7 digits or more.

If the remainder of specific numerals which can be resulted by addition, subtraction, multiplication, division, square etc with each digit itself is inputted meanwhile channel is not inputted, the result will be composed of 4 digits. It is almost impossible that an observer assume identifier and password with reverse assumption in order to use them later because he should achieve not only inputting method, reference signal, reference variable, password but also input equation by the content of input after observation with a standpoint as not user himself but observer.

Thus if an observer do not know at least one of the above elements, there is only a probability to agree by chance, and it is same in the case of observation.

In the present invention, methods by which the password control system helps user to set more easily will be omitted because it is not the intention of the present invention even if the skilled person in this field can produce various tools.

For an apparatus or system, which has display device, as like personal computer of ATM, unit for setting and identifying response time will be constructed more effectively than terminal as like telephone.

User can registers equation so that it can be set timer as a variable with one or more timers, which operates after establishment by reference signal from the password control system, established.

There could be various methods to exclude an observer, for example, regarding that numerals or characters between special numbers are negligent in order to confuse an observer, making specific channel valid under the condition that channel can be inputted when one number is specific one.

Variable referred at the input of password can be set in various ways according to the figure of the application to be adapted. In the case that visitor's number is published, user can make a reference with the last digit of his own visit number, and in the case of stock account, the composite stock exchange index or volume of his one stock could be referred.

In the case of a bank, password for account transmission would refer to a specific position of his account as a reference variable.

Thus reference variable would set by everything as long as the password control system and user could use it in common.

Password inputting method can be set according user's taste.

In addition to the above mentioned ways, day or hour can be used as a variable if user wants to change password periodically, equation composed of reference signal, reference variable and secret number etc can be used, a method that numerals without any relation with password is inserted as many as number of digits of reference signal during the inputting process and a method which user insert channel at the arbitrary position in front of, in rear of, or between the password.

Reference variable could not be used directly but be used in the twisted form by addition, subtraction, multiplication, and division with an equation or specific function.

Thus reference variable could be set by everything, which can be used by the password control system and user in common, and user can set password-inputting method freely.

The result following the input of “15293” is the same to the possible result which is produce by various composition of numerous password and numerous equation. Thus, nobody except user can know.

In order to increase the efficiency of the password control system, various methods could be used under the condition that a plurality of reference signals are given, for example, a method that each user use selected one at the specific position or the composed one based on the several reference signals.

If inputted time is measured and dated after endowment of reference number, user identification will be done more definitively by statistical way.

In order to protect against the program, which receive reference signal to process automatically, a method that reference signal is send in the form of graphic or image will be omitted because that those are additional feature to the present invention. Therefore detailed description about that will be omitted.

User can input password according to the way as he set at the user's standpoint while an embezzler cannot know what is calculated by reference number, which is invalid, which is channel by the result itself. Thus an embezzler cannot know password, password inputting method and required channel.

On the other hand, identification organization could be operated to relay user identification and at the standpoint of the third party who manages only password input method of user objectively with saving the password into management center (bank, credit card company, electric commerce site, etc) or user's coded belongings (for example, smart card, electric signature key, etc).

Here password saving method and saving method with cryptograph is suggested for the shake of saving password-inputting method.

For example in the case of closed loop type smart card, password control system are distributed on both sides when smart card and smart card reader is constructed by password control system. Identifying user, it is constructed by the method, which receives only result generated by the above-mentioned method.

Thus the idea of the present invention is applicable to various field of industry for example not only single device as like digital door lock but also key word for coding and decoding of the devices as like entrance management system, communication, file, digital signature key, smart card, card reader, etc. And the idea of present invention is applicable to electric commerce on the Internet electric money deal, credit card inquirer, ATM terminal small wireless communication device as like mobile telephone and PDA, and the field-transmitting signal mutually as like a mutual TV etc. The skilled person in this field can construct password control system for its own object easily without deviation of the scope of the present invention

As described above, because person cannot see what is the original password, which equation and variable is used with this password, the password cannot be embezzled even if video camera is established secretly.

According to the present invention, password cannot be embezzled in the input stage and hacking by intercept on the transmission line is to be in vain.

And because there is difference in the levels for construction of password according to user's taste, and password inputting method is composed of variable and equation set by each user, huge number of cases can be generated when someone tries to see by trials and errors so that very long time would be necessary still with computer processing. And input password found is not composed of exact password and password equation so that password cannot be used later.

The feature that the password cannot be reused can protect against large accident of credit gives a way to reduce chances to use collected authorities by hacking at once.

If turns of error input excesses an limitation, all the processes are initialized, thus measure which causes legitimate which suffers user, for example by account stop, can be is processed with considerable margin.

Difference of response speed, which depends on one's ability of memory and calculation, exists when password is inputted. However input speed in the normal state will be ranged within a certain range because user prefers to use usual method. For the others, because he has different response speed with mental calculation, password cannot be known by trials and errors. Although the content is right, it is processed as a disagreement so that it is difficult to discover or to use compulsively.

User's authorities can be protected by the function that changes authorities of the same identifier and informs a fact, using channel which could be set in the middle of, in front of or in rear of password even if password is used compulsively or temporarily.

The present invention has an effect to waste time and resources of hacker because he cannot know whether he accessed to original authorities.

Assuming that the timer which is operated only on the usage is used, if every user manages and check error processing time, he can recognize some one looking at his password so that he can response properly.

Although password file of bank or card company is stolen, embezzlement is difficult because identifier is modified with different method and password inputting method corresponding the same identifier, it is difficult to find password and password input method corresponding a identifier.

Password is saved to itself in the case of smart card, digital signature key which identifier is coded, it is safe even in the case that user manages password by saving password.

There is an effect that trial for hacking itself is in vain because probability of hacking could not be entrusted despite that much time and resource is paid despite of risk so as to embezzle password.

By the effects as described above, the present invention can be applicable to various fields in the industry which check of identification of user is necessary, for example in connection with card, bank account, digital signature key, and various electric document, user can be checked or identified objectively.

And in connection with various cards, identification card etc that are in the form of smart card, it is applicable as closed loop type, online type, etc.

And because password input can be done by numerals only, the present invention can be applicable to small device as like a remote controller, portable device, etc.

In the case that password can be input by voice, because it is good to speak that account number and password, even the disorder can do dealings which uses password.

Because current device can be adapted without modification or reconstruction to use the idea of the present invention, the present invention can be adapted rapidly over the entire industry and it is easily constructed and usage and application is easy for new devices.

In the view of the effects of the present invention, any body can understand that the present invention is applicable to various field of industry with common knowledge.

What is claimed is:

1. A method for identification of a user by the input of an indirect password comprising:
registering a password input method as a function composed of variables which are agreed with or assigned by a password control system; and
comparing an identifier and a password input by the user for identification with the variables which are agreed to or assigned by a password control system and a value calculated by the registered function.

2. The method as claimed in claim 1, wherein the password control system comprises
a password memory (1) for storing a password for an identifier;
a password input method memory (2) for storing an equation or a function having a basic variable of a password for the same identifier;
a reference variable memory (3) for storing variables, which are referred to when the user inputs, and a reference signal, management, device (4) for managing reference signals;
an output device (5);
a channel memory (6) for specifying a kind of exercise of authorities for the identifier;
an input device (7) to which the user inputs a result;
a response time memory (8) for storing a time for responding to the input;
a central processing unit (9) for comparing/analyzing the inputted response time and the result, identifying whether the registered password and the equation are known, and conducting/managing a process of the channel required by the user;
a temporary memory (10) necessary in processing;
an output port (11) communicated with the outside; and
a communication line (12) for transmitting/receiving signals among the above elements,
and wherein the method comprises the steps of
inputting an identifier which the user wishes to use (21);
inputting an indirect password by the user which is processed by the pre-registered password input method and reference signals, reference variables, constants and channel provided by the password control system (22);
classifying the result input by the user into an effective one and channel, and recalculating a response time according to a predetermined calculation method (23);
determining whether the inputted response time is within the response time which the user defined and comparing/analyzing the inputted response time with the result calculated by the password control system (24);
if the results are in accord with each other, assuming that the user is the right person for the identifier, conducting a process corresponding to the required channel (25); and
if the result input by the user is not in accord with the result calculated by the system, conducting a process for an unauthorized user (26).

3. The method as claimed in claim 1, wherein unnecessary data can be inserted or the channel which defines a process classifying the user's authorities can be input together, when variables provided by the password control system and the indirect password calculated by the function defined in advance are input.

4. The method as claimed in claim 1, wherein authorities of the identifier are classified by channels and different processes are provided according to the channel input by the user.

5. The method as claim in claim 1, wherein the response time in which the user inputs the password is checked.
